(19) United States
(12) Patent Application Publication
(10) Pub. No.: US 2014/0250952 A1
(43) Pub. Date: Sep. 11, 2014

(54) KEY CODED LOCK

(71) Applicant: Leo Lai, Zbangyang Zone (CN)

(72) Inventor: Leo Lai, Zbangyang Zone (CN)

(21) Appl. No.: 13/695,711

(22) PCT Filed: Dec. 30, 2011
(86) PCT No.: PCT/CN11/85035

§ 371 Date: Nov. 1, 2012

(30) Foreign Application Priority Data
Nov. 28, 2011 (CN) 201110384615.5

(51) Int. Cl. E05B 37/00

(52) U.S. Cl. CPC E05B 37/0034
USPC 70/14

(57) ABSTRACT

A key coded lock wherein the casing has a bottom shell and a surface shell; the cipher device is arranged on the left of the upper end face of the bottom shell; the lockset is arranged on the right of the upper end face of the bottom shell; the cipher device has a plurality of password wheels and a plurality of password adjustment wheels; the latch hook has a first straightline section, a bending section and a second straightline section; clamping grooves are formed on inner side faces of the password wheels; the lockset has a lock core, a sleeve and a latch hook sleeve; the lower end of the sleeve is connected with the lock core and the upper end of the sleeve is an open end and provided with an internal thread; a threaded rod engaged with the sleeve is formed on the latch hook sleeve.

### FIELD OF THE INVENTION

The invention relates to the technical field of coded locks, in particular to a key coded lock.

### BACKGROUND OF THE INVENTION

With the development of society, mechanical coded locks have been widely applied to people's lives, for example, common luggage code cases and code cabinets. Due to the use of the mechanical coded locks, the inconvenience brought by the carrying of physical keys can be eliminated, and the inconvenience brought by the fact that the physical keys are forgotten or lost can be also eliminated. The mechanical coded locks can only be unlocked by using passwords of the coded locks, and thus the operation is very simple. Moreover, each employee is equipped with a coded lock and then the labor is also saved during the normal management in companies. Therefore, the mechanical coded locks are favored by people of all ages. However, with the increasing pressure in the daily lives, people tend to forget something. If the passwords are forgotten, locksets must be damaged, and then the inconvenience is brought to people's lives. Furthermore, the inconvenience can also be brought to the work management in the collective livelihood. For example, each employee has corresponding cabinet and normally keeps his own items by adding a mechanical coded lock on the cabinet, and managers may open the cabinet by damaging the mechanical coded lock when the employee cannot unlock the mechanical coded lock as the employee is out of office or due to other reasons, and thus certain financial loss can be caused.

The invention patent Apl. No. 200620054273.5 is disclosed by the China Patent Bureau (now the State Intellectual Property Office of the P.R.C) on Jan. 31, 2007, with the title “Fingerprint Lock”. The fingerprint lock comprises a fingerprint input module, a fingerprint acquisition and recognition module electrically connected with the fingerprint input module, a lockset mechanical module, and a door lock master control driving module electrically connected with the fingerprint acquisition and recognition module and the lockset mechanical module respectively. The fingerprint lock uses a fingerprint of the human body as an unlocking key, and then the phenomenon that the lock cannot be unlocked due to the reason such as the forgetting of a password can be avoided. However, the fingerprint lock requires a power supply source and thus cannot be used in the case of power failure. Meanwhile, the fingerprint lock has very high cost and is not suitable to be widely applied in common people.

### SUMMARY OF THE INVENTION

The objective of the invention is to overcome the defects in the prior art and provide a key coded lock, in which the key coded lock can be unlocked by both a password and a physical key, and meanwhile, has the advantages of convenience in use and management and low cost.

The technical proposal of the invention is as follows:

The invention relates to a key coded lock, which comprises a casing, a cipher device, a latch hook and a lockset, wherein the casing has a bottom shell and a surface shell which are engaged with each other; the cipher device is arranged on the left of the upper end face of the bottom shell; the lockset is arranged on the right of the upper end face of the bottom shell; the cipher device has a password wheel set formed by a plurality of password wheels and a password adjustment wheel set formed by a plurality of password adjustment wheels engaged with the password wheels; the latch hook has a first straightline section, a bending section and a second straightline section; the first straightline section and the second straightline section are parallel to each other; both ends of the bending section are respectively connected with upper ends of the first and second straightline sections; projections of which the number is the same with that of the password adjustment wheels are formed on the side face of the first straightline section and distributed linearly; each password adjustment wheel has an annular column; a circular ring provided with an opening is formed inside the annular column; the openings of the circular rings are engaged with the projections; the circular rings are engaged with the first straightline section; the lower end portion of the first straightline section is sleeved into the circular rings; clamping bodies are formed on lower end portions of outer side faces of the annular columns; clamping grooves engaged with the clamping bodies are formed on inner side faces of the password wheels; the password wheels are sleeved on lower end portions of the annular columns; through holes engaged with the password wheels and password adjustment holes for mounting the password adjustment wheels are formed on the left central section of the bottom shell; a lower plughole for the first straightline section to be inserted is formed on the top left of the bottom shell; the lockset has a lock core, a sleeve and a latch hook sleeve; a lower lockhole for mounting the lock core is formed on the right bottom of the bottom shell; a sleeve hole for mounting the sleeve is formed on the lockhole of the bottom shell; a lower latch hook sleeve hole for mounting the latch hook sleeve is formed on the sleeve hole of the bottom shell; the lock core is arranged inside the lockhole; the sleeve is arranged inside the sleeve hole; the lower end of the sleeve is connected with the lock core and the upper end of the sleeve is an open end and provided with an internal thread; a threaded rod engaged with the sleeve is formed on the lower end portion of the latch hook sleeve; the upper end portion of the latch hook sleeve is extended out of the bottom shell and provided with a mounting hole for mounting the lower end portion of the second straightline section; and the second straightline section is positioned on the bottom shell.

Moreover, the bottom shell is provided with a convex connecting column; the surface shell is provided with a plughole engaged with the connecting column; and the connecting column is inserted into and clamped with the plughole.

Furthermore, a connecting body is formed on the lower end of the sleeve; connecting holes are formed on the lower end of the connecting body; and driving blocks deviated from an axial line of the lock core are formed on the upper end of the lock core and engaged with and inserted into the connecting holes.

Still further, the number of the driving blocks and the number of the connecting holes are both two; and the two driving blocks are symmetrically arranged relative to the axial line of the lock core.

Preferably, a spring plate is also arranged on the bottom shell and has a stator and elastic plates; and one ends of the elastic plates are connected with the stator and the other ends of the elastic plates are positioned between the password wheels and the bottom shell.

Preferably, a pressure plate is arranged under the stator; both the stator and the pressure plate are provided with a plurality of circular holes engaged with each other; and a plurality of fixing columns engaged with the circular holes are formed in the middle of the surface shell and inserted into the circular holes.

Moreover, through holes used for the rotation of the password wheels are formed on the left central section of the surface shell; an upper plughole is formed on the top left of the surface shell; the upper plughole and the lower plughole are engaged with each other to form a plughole for the first straightline section to be inserted; an upper lockhole is formed on the right bottom of the surface shell; the upper lockhole and the lower lockhole are engaged with each other to form a lockhole for mounting the lock core; an upper latch hook sleeve hole is formed on the top right of the surface shell; and the upper latch hook sleeve hole and the lower latch hook sleeve hole are engaged with each other to form a latch hook sleeve hole for mounting the latch hook sleeve.

Furthermore, a convex clamping block is formed on the side face of the first straightline section and positioned on the projections; the bottom shell is provided with a spacing hole 134; a stop block is formed inside the spacing hole 134; when the lower end face of the clamping block makes contact with the stop block, the lower end face of the second straightline section is positioned on the casing; a spacing groove 133 along which the clamping block moves is formed aside the lower plughole of the bottom shell; and when the clamping block moves to the upper bottom of the spacing groove 133, the projections on the side face of the first straightline section are all positioned inside the annular columns of the password adjustment wheels corresponding to the projections and the lower end of the second straightline section is disengaged from the latch hook sleeve.

Preferably, a lower password adjustment hole is formed on the left bottom of the bottom shell; a password adjustment spring is arranged inside the lower password adjustment hole; one end of the password adjustment spring is butted with a password adjustment wheel at the bottom and the other end of the password adjustment spring is butted with the lower end face of the lower password adjustment hole; and a spacer is arranged between the password adjustment spring and the password adjustment wheel.

In addition, the spacer is arranged between the spring and the password adjustment wheel. The aperture area of the spacer is less than that of the password adjustment wheel, so that the spacer can make contact with the spring conveniently.

Moreover, a password search device is arranged in the middle of the bottom shell and has a movable block and a plurality of password search rods; password search holes are formed on upper end portions of side faces of the password adjustment wheels; when the projections on the side face of the latch hook are engaged with the openings of the circular rings on the inner side faces of the password adjustment wheels, the password search holes turn towards the right; a plurality of mounting holes are formed on the front end portion of the left of the movable block; password search springs are arranged inside the mounting holes; one ends of the password search rods are extended into the mounting holes and butted with the password search springs and the other ends of the password search rods correspond to the password search holes; a password search device hole engaged with the password search device is formed in the middle of the bottom shell; offsetting springs are arranged on the left of the password search device hole; one ends of the offsetting springs are butted with the left end face of the password search device hole and the other ends of the offsetting springs are butted with the rear end portion of the left of the movable block; a push rod is formed on the side face of the sleeve; and when the sleeve is driven to rotate until the latch hook sleeve is extended into the casing, the push rod is positioned on the left of the sleeve.

Furthermore, a plurality of password search blocks protruded to the left are formed on the front end portion of the left of the movable block; the mounting holes of the movable block are formed on left end faces of the password search blocks and are conical through holes; and the password search rods are conical rods.

Still further, the sleeve consists of a spiral upper cover and a spiral lower cover; a clamping column is formed on the lower end face of the spiral upper cover; a clamping hole is formed on the upper end face of the spiral lower cover; and the clamping column is extended into the clamping hole.

Still further, a slide block is formed on the right of the movable block; a sliding groove engaged with the slide block is formed on the right central section of the bottom shell; and a movable groove engaged with the push rod is formed in the middle of the slide block.

Still further, positioning columns engaged with the offsetting springs are formed on the left bottom of the movable block; and the offsetting springs are sleeved on the positioning columns.

The key coded lock has the advantages that: The invention relates to a key coded lock, which comprises a casing, a cipher device, a latch hook and a lockset, wherein the casing has a bottom shell and a surface shell which are engaged with each other; the cipher device is arranged on the left of the upper end face of the bottom shell; the lockset is arranged on the right of the upper end face of the bottom shell; the cipher device has a password wheel set formed by a plurality of password wheels and a password adjustment wheel set formed by a plurality of password adjustment wheels engaged with the password wheels; the latch hook has a first straightline section, a bending section and a second straightline section; the first straightline section and the second straightline section are parallel to each other; both ends of the bending section are respectively connected with upper ends of the first and second straightline sections; projections of which the number is the same with that of the password adjustment wheels are formed on the side face of the first straightline section and distributed linearly; each password adjustment wheel has an annular column; a circular ring provided with an opening is formed inside the annular column; the openings of the circular rings are engaged with the projections; the circular rings are engaged with the first straightline section; the lower end portion of the first straightline section is sleeved into the circular rings; clamping bodies are formed on lower end portions of outer side faces of the annular columns; clamping grooves engaged with the clamping bodies are formed on inner side faces of the password wheels; the password wheels are sleeved on lower end portions of the annular columns; through holes engaged with the password wheels and password adjustment holes for mounting the password adjustment wheels are formed on the left central section of the bottom shell; a lower plughole for the first straightline section to be inserted is formed on the top left of the bottom shell; the lockset has a lock core, a sleeve and a latch hook sleeve; a lower lockhole for mounting the lock core is formed on the right bottom of the bottom shell; a sleeve hole for mounting the sleeve is formed on the lockhole of the bottom shell; a lower latch hook sleeve hole for mounting the latch hook sleeve is formed on the sleeve hole of the bottom shell; the lock core is arranged inside the lockhole; the sleeve is arranged inside the sleeve hole; the lower end of the sleeve is connected with the lock core and the upper end of the sleeve is an open end and provided with an internal thread; a threaded rod engaged with the sleeve is formed on the lower end portion of the latch hook sleeve; the upper end portion of the latch hook sleeve is extended out of the bottom shell and provided with a mounting hole for mounting the lower end portion of the second straightline section; and the second straightline section is positioned on the bottom shell. By arrangement of the cipher device and the lockset inside the casing, the key coded lock can be unlocked by both a password and a physical key, so that the key coded lock is convenient to unlock and manage. Moreover, by adoption of the password search device, the key can also be used for unlocking and password search.

### BRIEF DESCRIPTION OF THE DRAWINGS

FIG. 1 is an exploded view of an embodiment 1 of the key coded lock provided by the invention;

FIG. 2 is a structure diagram of a latch hook of the key coded lock provided by the invention;

FIG. 3 is a structure diagram of a password adjustment wheel of the embodiment 1 of the key coded lock provided by the invention;

FIG. 4 is a structure diagram of a password wheel of the key coded lock provided by the invention;

FIG. 5 is a structure diagram of a spring plate of the key coded lock provided by the invention;

FIG. 6 is a structure diagram of a sleeve of the embodiment 1 of the key coded lock provided by the invention;

FIG. 7 is a structure diagram of the embodiment 1 of the key coded lock provided by the invention after a surface shell is removed;

FIG. 8 is an exploded view of an embodiment 2 of the key coded lock provided by the invention;

FIG. 9 is a structure diagram of a password adjustment wheel of the embodiment 2 of the key coded lock provided by the invention;

FIG. 10 is a structure diagram of the embodiment 2 of the key coded lock provided by the invention after a surface shell, a latch hook sleeve, a lock core and a spring plate are removed;

FIG. 11 is a structure diagram of a bottom shell of the embodiment 2 of the key coded lock provided by the invention;

FIG. 12 is a structure diagram of a surface shell of the key coded lock provided by the invention;

FIG. 13 is a structure diagram of a spiral lower cover of the embodiment 2 of the key coded lock provided by the invention;

FIG. 14 is a structure diagram of a spiral upper cover of the embodiment 2 of the key coded lock provided by the invention;

FIG. 15 is a structure diagram of a sleeve of the embodiment 2 of the key coded lock provided by the invention;

FIG. 16 is a structure diagram of a cipher device of the embodiment 2 of the key coded lock provided by the invention; and

FIG. 17 is a structure diagram of the cipher device as illustrated in FIG. 16 seen from another angle.

### DETAILED DESCRIPTION OF THE PREFERRED EMBODIMENTS

Further description is given to the invention with the attached drawings and preferred embodiments.

### Embodiment 1

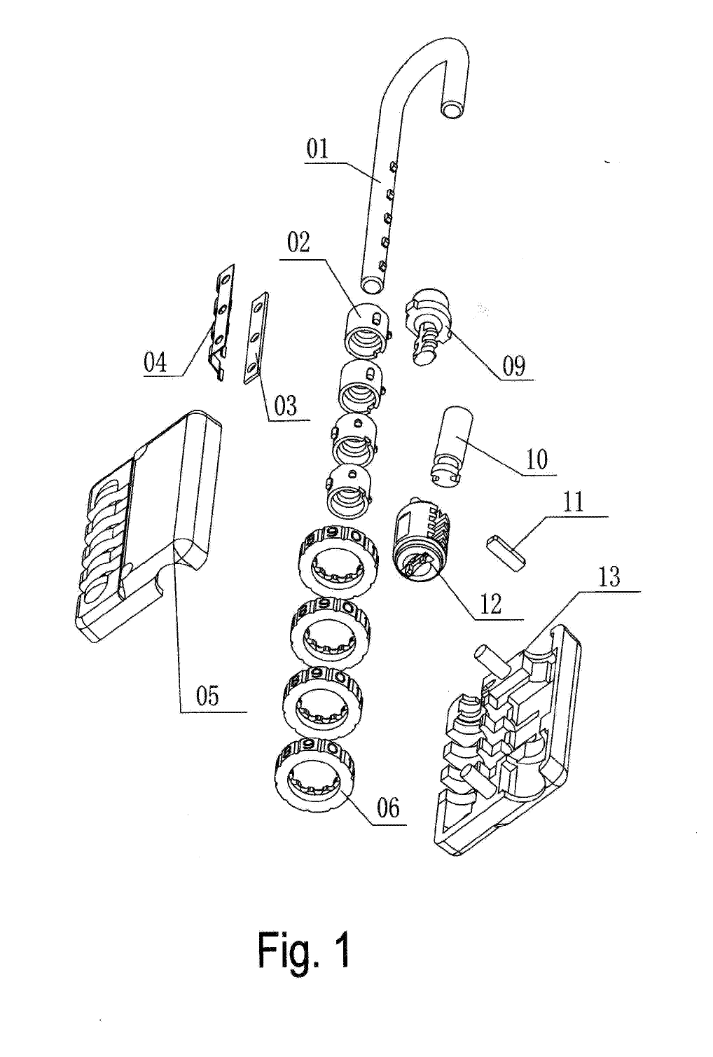

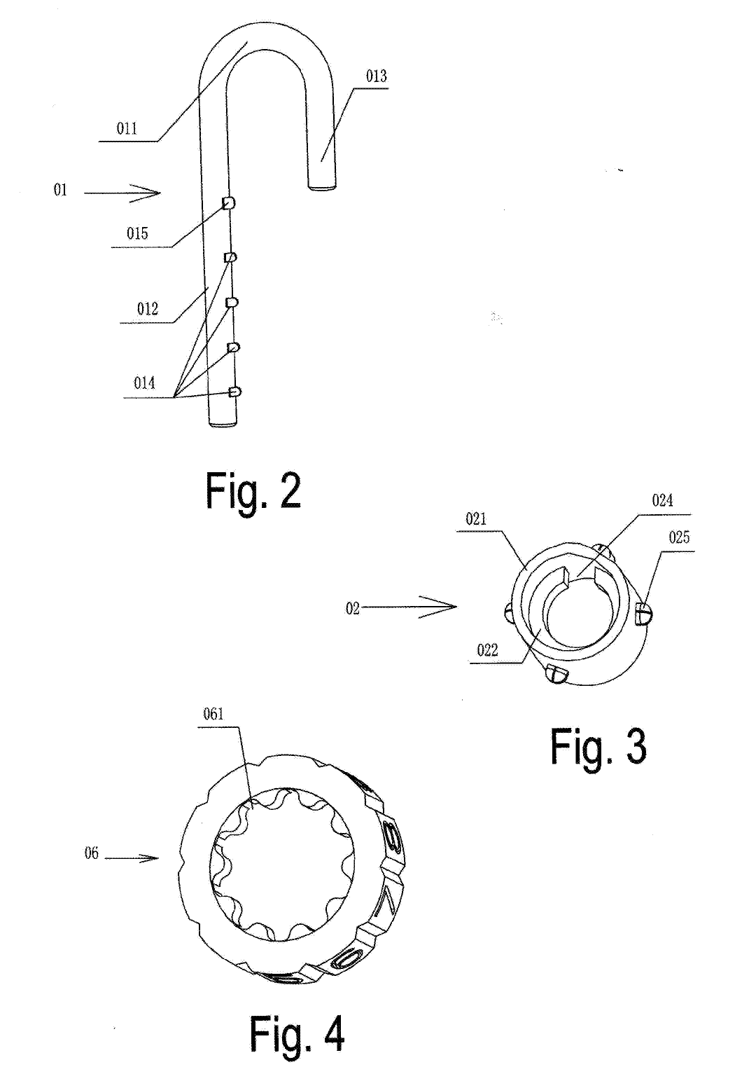

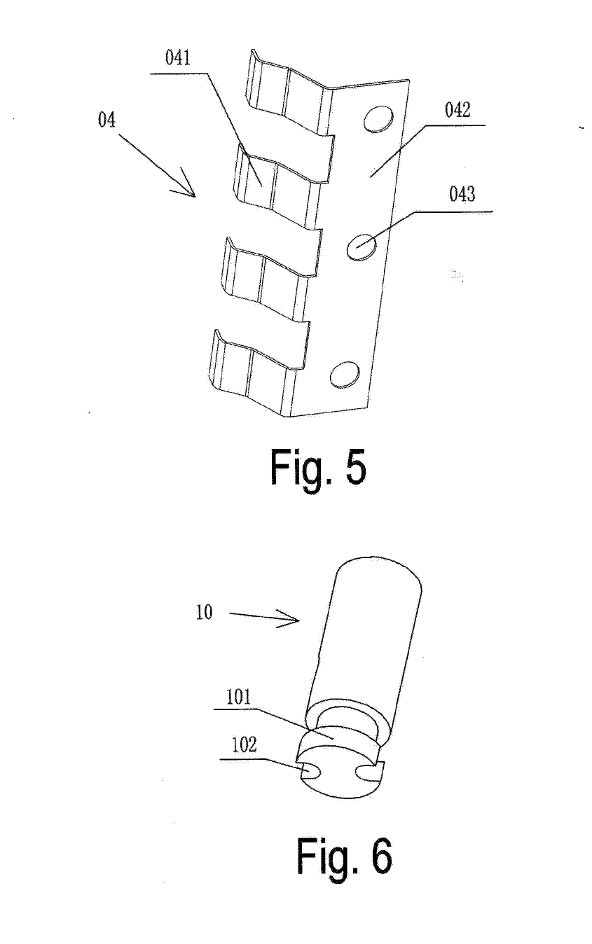

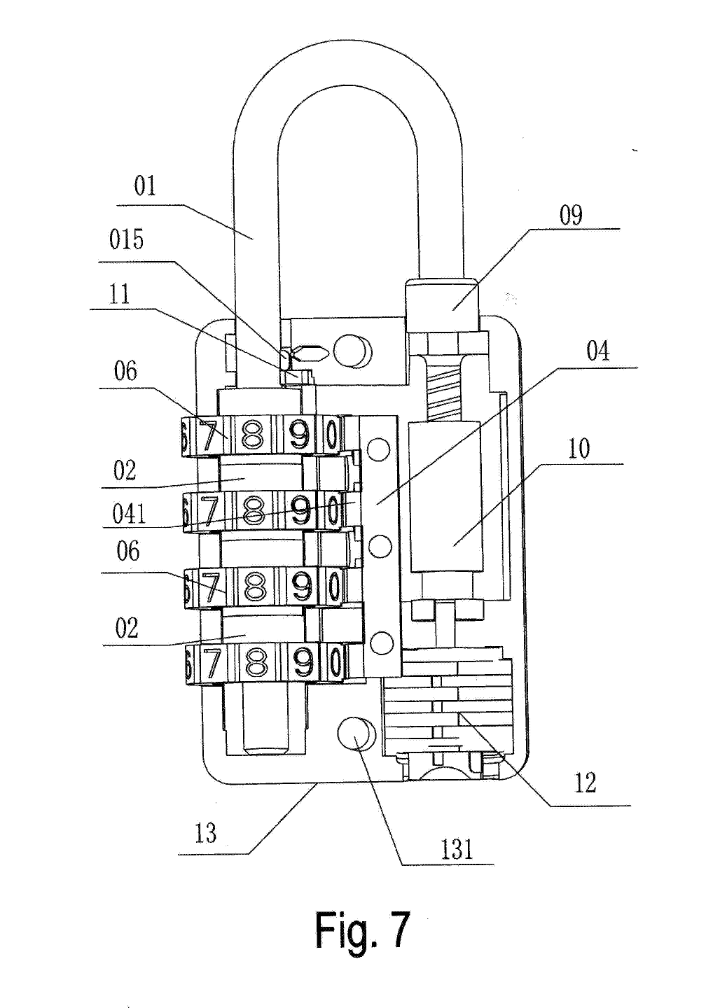

As illustrated in FIGS. 1 to 7, the invention relates to a key coded lock, which comprises a casing, a cipher device, a latch hook 01 and a lockset, wherein the casing has a bottom shell 13 and a surface shell 05 which are engaged with each other; the cipher device is arranged on the left of the upper end face of the bottom shell 13; the lockset is arranged on the right of the upper end face of the bottom shell 13; the cipher device has a password wheel set formed by a plurality of password wheels 06 and a password adjustment wheel set formed by a plurality of password adjustment wheels 02 engaged with the password wheels 06; the latch hook 01 has a first straightline section 012, a bending section 011 and a second straightline section 013; the first straightline section 012 and the second straightline section 013 are parallel to each other; both ends of the bending section 011 are respectively connected with upper ends of the first straightline section 012 and the second straightline section 013; projections 014 of which the number is the same with that of the password adjustment wheels 02 are formed on the side face of the first straightline section 012 and distributed linearly; each password adjustment wheel 02 has an annular column 021; a circular ring 022 provided with an opening 024 is formed inside the annular column 021; the openings 024 of the circular rings 022 are engaged with the projections 014; the circular rings 022 are engaged with the first straightline section 012; the lower end portion of the first straightline section 012 is sleeved into the circular rings 022; clamping bodies 025 are formed on lower end portions of outer side faces of the annular columns 021; clamping grooves 061 engaged with the clamping bodies 025 are formed on inner side faces of the password wheels 06; the password wheels 06 are sleeved on lower end portions of the annular columns 021; through holes 135 engaged with the password wheels 06 and password adjustment holes for mounting the password adjustment wheels 02 are formed on the left central section of the bottom shell 13; a lower plughole for the first straightline section 012 to be inserted is formed on the top left of the bottom shell 13; the lockset has a lock core 12, a sleeve 10 and a latch hook sleeve 09; a lower lockhole 132 for mounting the lock core 12 is formed on the right bottom of the bottom shell 13; a sleeve hole for mounting the sleeve 10 is formed on the lockhole of the bottom shell 13; a lower latch hook sleeve hole for mounting the latch hook sleeve 09 is formed on the sleeve hole of the bottom shell 13; the lock core 12 is arranged inside the lockhole; the sleeve 10 is arranged inside the sleeve hole; the lower end of the sleeve 10 is connected with the lock core 12 and the upper end of the sleeve 10 is an open end and provided with an internal thread; a threaded rod engaged with the sleeve 10 is formed on the lower end portion of the latch hook sleeve 09; the upper end portion of the latch hook sleeve 09 is extended out of the bottom shell 13 and provided with a mounting hole for mounting the lower end portion of the second straightline section 013; and the second straightline section 013 is positioned on the bottom shell 13.

The key coded lock can be unlocked by both a password and a key. When the key coded lock is in the locked state, firstly, the password is used for unlocking the key coded lock. The password is adjusted to be correct first, and the password adjustment wheels 02 may be driven to rotate when the password wheels 06 rotates. When the password is adjusted to be correct, the openings 024 of the circular rings 022 on the inner side faces of the password adjustment wheels 02 are all distributed linearly and engaged with the projections 014 of the first straightline section 012 of the latch hook 01. That is to say, when the latch hook 01 is pulled up herein, the latch hook 01 may be driven to move up until the latch hook 01 is disengaged from the casing, and then the unlocking function can be realized. Secondly, the key is used for unlocking the key coded lock. The correct key is inserted into the lock core 12 which is driven to rotate, and then the sleeve 10 may be driven to rotate by the lock core 12. As the sleeve 10 is threadedly connected with the latch hook sleeve 09, the lower end portion of the latch hook sleeve 09 may be screwed into the sleeve 10 when the sleeve 10 is driven to rotate, and then the latch hook sleeve 09 may be driven to move towards the inside of the casing until the latch hook sleeve 09 is completely extended into the casing. Herein, the second straightline section 013 of the latch hook 01 is positioned on the casing, and then the key coded lock is unlocked.

Moreover, the bottom shell 13 is provided with a convex connecting column 131; the surface shell 05 is provided with a plughole 051 engaged with the connecting column 131; and the connecting column 131 is inserted into and clamped with the plughole 051. Therefore, the bottom shell 13 and the surface shell 05 are fixedly connected with each other via the clamped connection of the connecting column 131 and the plughole 051.

Furthermore, a connecting body 101 is formed on the lower end of the sleeve 10; connecting holes 102 are formed on the lower end of the connecting body 101; and driving blocks deviated from an axial line of the lock core 12 are formed on the upper end of the lock core 12 and engaged with and inserted into the connecting holes 102. The sleeve 10 and the lock core 12 are connected with each other by means of inserting, and thus the structure is simple. When the lock core 12 rotates, the sleeve 10 is driven to rotate by the driving blocks.

Still further, the number of the driving blocks and the number of the connecting holes 102 are both two; and the two driving blocks are symmetrically arranged relative to the axial line of the lock core. By adoption of the two driving blocks and due to the symmetrical arrangement of the two driving blocks, a couple is produced during the rotation of the driving blocks, and thus the convenience is provided for the driving blocks to drive the sleeve 10 to rotate.

Preferably, a spring plate 04 is also arranged on the bottom shell 13 and has a stator 042 and elastic plates 041; and one ends of the elastic plates 041 are connected with the stator 042 and the other ends of the elastic plates 041 are positioned between the password wheels 06 and the bottom shell 13. By adoption of the spring plate 04, the password wheels 06 may be blocked by the spring plate 04 when rotating, and thus the sense of strength is higher during the rotation of the password wheels 06 and the operation is convenient.

Preferably, a pressure plate 03 is arranged under the stator 042; both the stator 042 and the pressure plate 03 are provided with a plurality of circular holes 043 engaged with each other; and a plurality of fixing columns 052 engaged with the circular holes 043 are formed in the middle of the surface shell 05 and inserted into the circular holes 043. By adoption of the pressure plate 03 and the circular holes 043, the spring plate 04 can be conveniently fixed.

Moreover, through holes used for the rotation of the password wheels 06 are formed on the left central section of the surface shell 05; an upper plughole is formed on the top left of the surface shell 05; the upper plughole and the lower plughole are engaged with each other to form a plughole for the first straightline section 012 to be inserted; an upper lockhole is formed on the right bottom of the surface shell 05; the upper lockhole and the lower lockhole 132 are engaged with each other to form a lockhole for mounting the lock core 12; an upper latch hook sleeve hole is formed on the top right of the surface shell 05; and the upper latch hook sleeve hole and the lower latch hook sleeve hole are engaged with each other to form a latch hook sleeve hole for mounting the latch hook sleeve 09. By arranging the upper plughole, the upper lockhole, the upper latch hook sleeve hole and the like on the surface shell 05 correspondingly, the key coded lock is convenient to assemble.

Furthermore, a convex clamping block 015 is formed on the side face of the first straightline section 012 and positioned on the projections 014; the bottom shell 13 is provided with a spacing hole 134; a stop block 11 is formed inside the spacing hole 134; when the lower end face of the clamping block 015 makes contact with the stop block 11, the lower end face of the second straightline section 013 is positioned on the casing; a spacing groove 133 along which the clamping block 015 moves is formed aside the lower plughole of the bottom shell 13; and when the clamping block 015 moves to the upper bottom of the spacing groove 133, the projections 014 on the side face of the first straightline section 012 are all positioned inside the annular columns 021 of the password adjustment wheels 02 corresponding to the projections 014 and the lower end of the second straightline section 013 is disengaged from the latch hook sleeve 09. By adoption of the clamping block 015, the stop block 11, the spacing hole 134 and the spacing groove 133, the moving distance of the latch hook 01 during the unlocking can be limited and the latch hook 01 can be limited to move in the casing within a short distance, and thus the latch hook 01 can be prevented from being disengaged from the casing.

### Embodiment 2

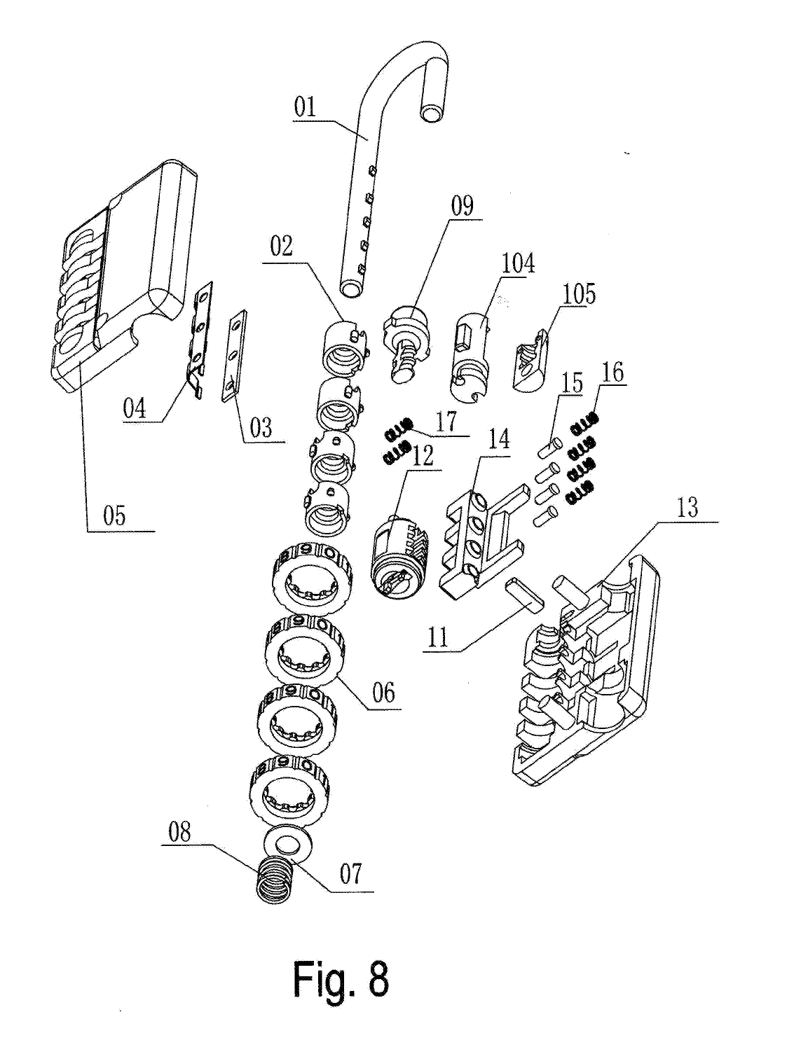

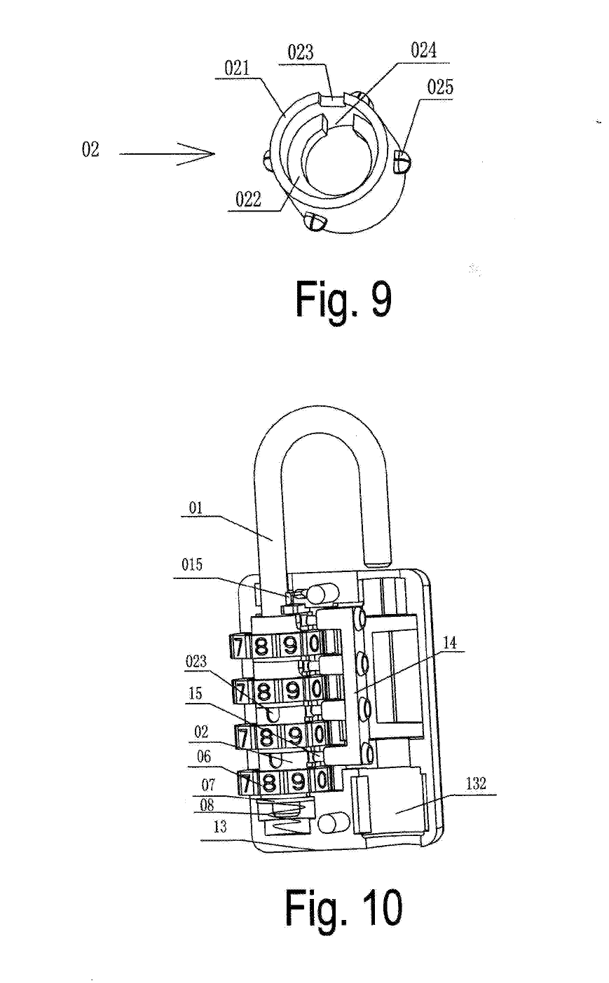

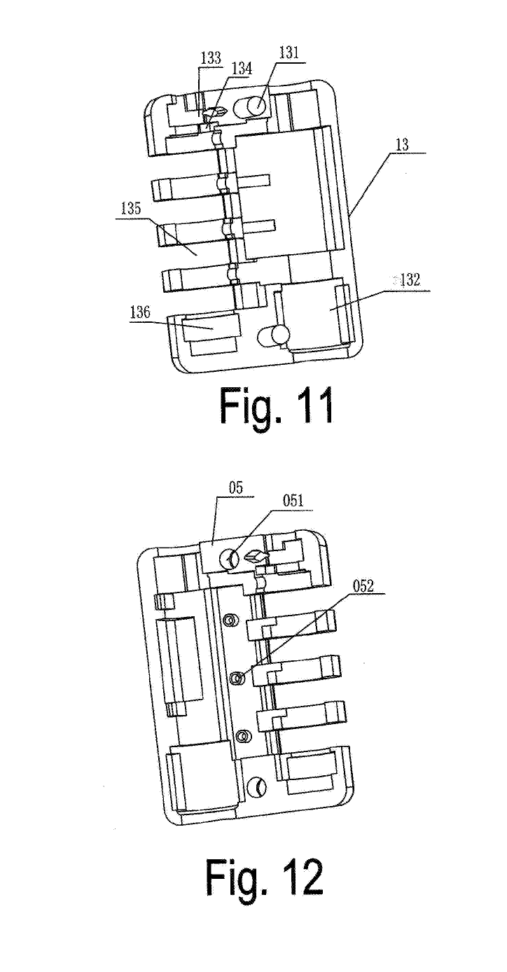

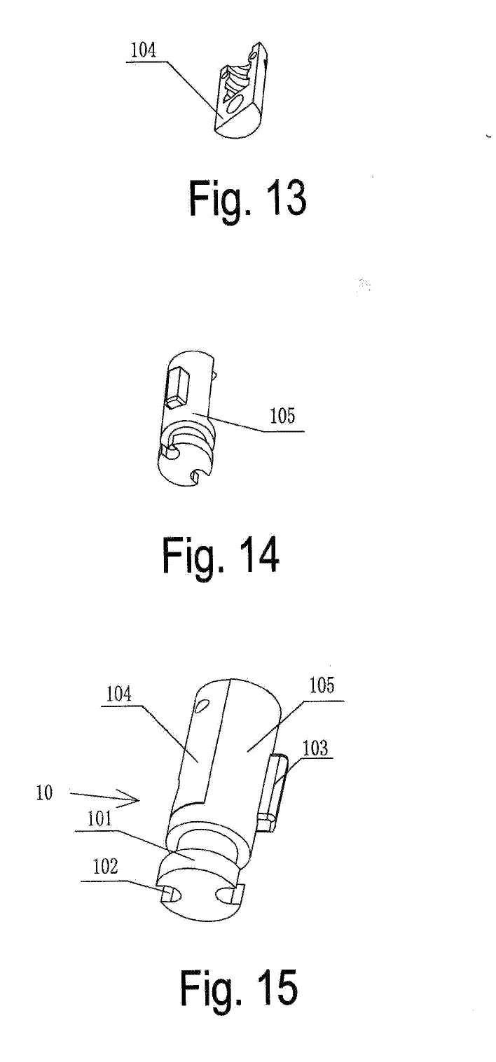

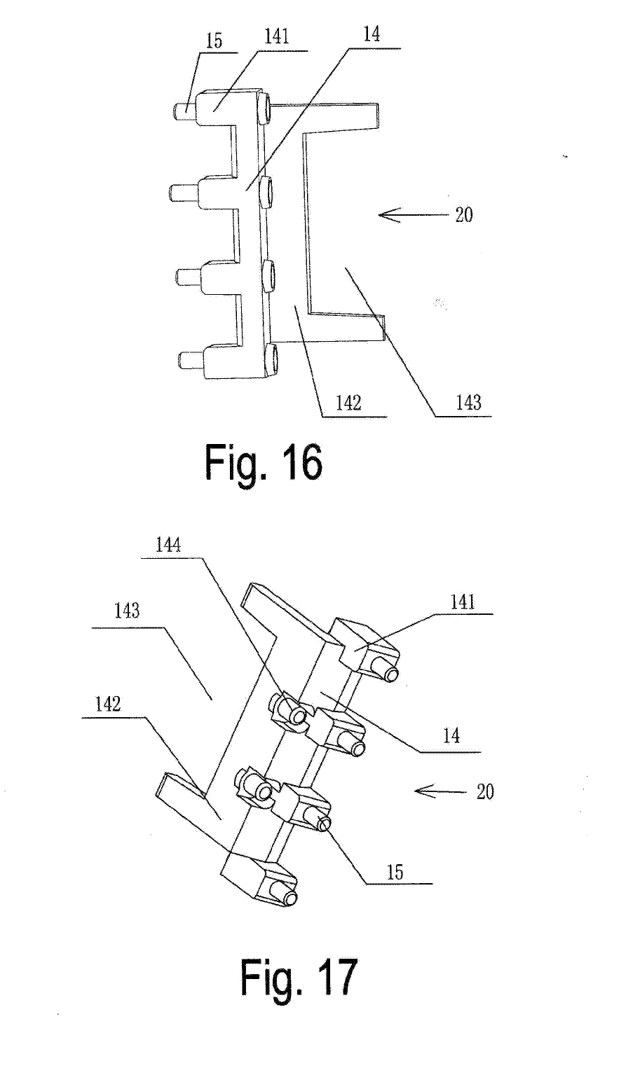

As illustrated in FIGS. 8 to 17, the structure of the key coded lock is basically the same with that of the embodiment 1, with the differences as follows:

A lower password adjustment hole 136 is formed on the left bottom of the bottom shell 13; a password adjustment spring 08 is arranged inside the lower password adjustment hole 136; one end of the password adjustment spring 08 is butted with a password adjustment wheel 02 at the bottom and the other end of the password adjustment spring 08 is butted with the lower end face of the lower password adjustment hole 136; and a spacer 07 is arranged between the password adjustment spring 08 and the password adjustment wheel 02. By adoption of the lower password adjustment hole 136, the cipher device may perform password setting. During the password setting, the password is adjusted to be correct first; the latch hook 01 is driven to move up until the projections 014 on the side face of the first straightline section 012 are positioned on the openings 024 of the circular rings 022 on the inner side faces of the corresponding password adjustment wheels 02, and herein the lower end of the second straightline section 013 is disengaged from the latch hook sleeve; one end of the latch hook 01 is driven to rotate for certain angle, and then latch hook 01 is pressed down; the projections 014 on the side face of the latch hook 01 are driven to move down to make contact with the circular rings 022 on the inner side faces of the password adjustment wheels 02, and the password adjustment wheels 02 are driven to move down, so that the clamping bodies 025 on the outer side faces of the password adjustment wheels 02 are driven to be disengaged from the clamping grooves 061 of the password adjustment wheels 02, namely the password wheels 06 are positioned on the upper end portions of the password adjustment wheels 02; herein, the password wheels 06 can be driven to rotate for password adjustment; after the password is adjusted to be correct, the latch hook 01 is loosened; herein, the password adjustment wheels 02 are driven to move up and be reset under the elastic force of the password adjustment springs 08, and meanwhile the latch hook 01 is driven to move up; after the password adjustment wheels 02 is driven to move up, the clamping bodies 025 of the password adjustment wheels 02 are engaged with the clamping grooves 061 of the password wheels 06 again; subsequently, the latch hook 01 is driven to rotate to an unlocking position and then pressed down, so that the projections 014 on the side face of the first straightline section 012 of the latch hook 01 are positioned under the openings 024 of the circular rings 022 of the corresponding password adjustment wheels 02, and meanwhile, the lower end face of the second straightline section 013 of the latch hook 01 is extended into the latch hook sleeve 09; finally the password is disorganized, and the password wheels 06 drive the password adjustment wheels 02 to rotate, so that at least one projection 014 on the side face of the first straightline section 012 of the latch hook 01 does not correspond to the circular ring 022 of the opening of the corresponding password adjustment wheel 02; and then the latch hook 01 is clamped into the password adjustment wheel 02 and cannot move.

In addition, the spacer 07 is arranged between the password adjustment spring 08 and the password adjustment wheel 02. The aperture area of the spacer 07 is less than that of the password adjustment wheel 02, so that the spacer 07 can make contact with the spring conveniently.

Moreover, a password search device 20 is arranged in the middle of the bottom shell 13 and has a movable block 14 and a plurality of password search rods 15; password search holes 023 are formed on upper end portions of side faces of the password adjustment wheels 02; when the projections 014 on the side face of the latch hook 01 are engaged with the openings 024 of the circular rings 022 on the inner side faces of the password adjustment wheels 02, the password search holes 023 turn towards the right; a plurality of mounting holes are formed on the front end portion of the left of the movable block 14; password search springs 16 are arranged inside the mounting holes; one ends of the password search rods 15 are extended into the mounting holes and butted with the password search springs 16 and the other ends of the password search rods 15 correspond to the password search holes 023; a password search device hole is formed in the middle of the bottom shell 13; offsetting springs 17 are arranged on the left of the password search device hole; one ends of the offsetting springs 17 are butted with the left end face of the password search device hole and the other end of the offsetting springs 17 are butted with the rear end portion of the left of the movable block 14; a push rod 103 is formed on the side face of the sleeve 10; and when the sleeve 10 is driven to rotate until the latch hook sleeve 09 is extended into the casing, the push rod 103 is positioned on the left of the sleeve 10. When the password is forgotten, the key can be used for unlocking and password search. During the operation, the correct key is inserted into the lock core 12 first and the lock core 12 is driven to rotate, and then the sleeve 10 is driven to rotate by the lock core 12; when the sleeve 10 is driven to rotate until the latch hook sleeve 09 is extended into the casing, the push rod 103 is positioned on the left of the sleeve 10; in the process, the movable block 14 is gradually pushed to the left by the sleeve 10; after the movable block 14 is driven to move to the left, the password search rods 15 in the mounting holes of the movable block 14 are also driven to move to the left; if the password search rods 15 are inserted into the corresponding password search holes 023, the corresponding password wheels 06 of the password adjustment wheels 02 are correct when the corresponding password adjustment wheels 02 of the password adjustment rods are at the unlocking position; if the password search rods 15 are not inserted into the corresponding password search holes 023, the password adjustment wheels 02 can rotate, that is to say, the password wheels 06 can rotate as well; when the password wheels 06 rotates, the password adjustment wheels 02 are driven to rotate until the password search rods 15 are inserted into the corresponding password search holes 023 under the thrust force of the password search springs 16; and when all the password search rods 15 are inserted into the password search holes 023, all the password wheels 06 do not rotate and are also in the correct password state, and then the password search process is completed. Once the key is used and the key coded lock is in the unlocking state, the push rod 103 is driven to be disengaged from the left of the sleeve 10 by the rotation of the key; the movable block 14 is driven to move to the right under the action of the offsetting springs 17; and the password search rods 15 are disengaged from the password search holes 023. The key coded lock has the advantages that: the structure is simple; by skillful combination of the password and the physical key, the trouble caused by the fact that the password is forgotten or the person knowing the password is out can be avoided; the management is convenient; and by adoption of the cipher device 20, the password can be found when the key is used for unlocking the key coded lock.

Furthermore, a plurality of password search blocks 141 protruded to the left are formed on the front end portion of the left of the movable block 14; and the mounting holes are formed on left end faces of the password search blocks 141. By adoption of the convex password search blocks 141, the materials and space can be saved.

Still further, a plurality of through holes engaged with the password search rods 15 are formed on right sides of the password adjustment holes (as illustrated in FIGS. 8, 10 and 11). When the right sides of the password adjustment holes are designed to prevent the password search rods 15 from inserting into the password search holes 023, the through holes engaged with the password search rods 15 can be opened to help left sides of the password search rods 15 to be inserted into the password search holes 023.

Still further, the mounting holes are conical through holes, and the password search rods 15 are conical rods. The conical rods can be limited by the conical holes, and the assembly and operation are also convenient.

Still further, the sleeve 10 consists of a spiral upper cover 105 and a spiral lower cover 104; a clamping column is formed on the lower end face of the spiral upper cover 105; a clamping hole is formed on the upper end face of the spiral lower cover 104; and the clamping column is extended into the clamping hole. By separation of the sleeve 10 into two parts, namely the spiral upper cover 105 and the spiral lower cover 104, the processing is convenient.

Still further, a slide block 142 is formed on the right of the movable block 14; a sliding groove 143 engaged with the slide block 142 is formed on the right central section of the bottom shell 13; and a movable groove engaged with the push rod 103 is formed in the middle of the slide block 142. Due to the arrangement of the slide block 142 and the sliding groove 143, the movable block 14 is driven to perform directional movement under the thrust force of the push rod 103, namely the slide block 142 is driven to move to the left along the sliding groove 143, so that the shaking of the movable block 14 can be avoided. Moreover, due to the arrangement of the sliding groove 143, the push rod 103 can make contact with the movable block 14 conveniently. As the vertical length of the sliding groove 143 is the same with that of the push rod 103, the engagement is tight.

Still further, positioning columns 144 engaged with the offsetting springs 17 are arranged on the left bottom of the movable block 14; and the offsetting springs 17 are sleeved on the positioning columns 144. Due to the arrangement of the positioning columns 144, the offsetting springs 17 can be limited on the positioning columns 144, so that the phenomenon that the function of resetting the movable block 14 cannot be realized as the offsetting springs 17 are offset due to the shaking of the device can be avoided.

Detailed description is given to the invention. It shall be understood by those skilled in the art that modifications or equivalent replacements can be made on the technical proposal of the invention without departing from the essence and scope of the technical proposal of the invention.

What is claimed is:

1. A key coded lock, comprising a casing, a cipher device, a latch hook and a lockset, wherein the casing having a bottom shell and a surface shell engaged with each other; the cipher device arranged on the left of the upper end face of the bottom shell; the lockset arranged on the right of the upper end face of the bottom shell; the cipher device having a password wheel set formed by a plurality of password wheels and a password adjustment wheel set formed by a plurality of password adjustment wheels engaged with the password wheels; the latch hook having a first straightline section, a bending section and a second straightline section; the first straightline section and the second straightline section being parallel to each other; both ends of the bending section respectively connected with upper ends of the first and second straightline sections; projections of which the number being the same with that of the password adjustment wheels formed on the side face of the first straightline section and distributed linearly; each password adjustment wheel having an annular column; a circular ring provided with an opening formed inside the annular column; the openings of the circular rings engaged with the projections; the circular rings engaged with the first straightline section; the lower end portion of the first straightline section sleeved into the circular rings; clamping bodies formed on lower end portions of outer side faces of the annular columns; clamping grooves engaged with the clamping bodies formed on inner side faces of the password wheels; the password wheels sleeved on lower end portions of the annular columns; through holes engaged with the password wheels and password adjustment holes for mounting the password adjustment wheels formed on the left central section of the bottom shell; a lower plughole for the first straightline section to be inserted formed on the top left of the bottom shell; the lockset having a lock core, a sleeve and a latch hook sleeve; a lower lockhole for mounting the lock core formed on the right bottom of the bottom shell; a sleeve hole for mounting the sleeve formed on the lockhole of the bottom shell; a lower latch hook sleeve hole for mounting the latch hook sleeve formed on the sleeve hole of the bottom shell; the lock core arranged inside the lockhole; the sleeve arranged inside the sleeve hole; the lower end of the sleeve connected with the lock core and the upper end of the sleeve being an open end and provided with an internal thread; a threaded rod engaged with the sleeve formed on the lower end portion of the latch hook sleeve; the upper end portion of the latch hook sleeve extended out of the bottom shell and provided with a mounting hole for mounting the lower end portion of the second straightline section; and the second straightline section positioned on the bottom shell.

2. The key coded lock according to claim 1, wherein a connecting body is formed on the lower end of the sleeve; connecting holes are formed on the lower end of the connecting body; and driving blocks deviated from an axial line of the lock core are formed on the upper end of the lock core and engaged with and inserted into the connecting holes.

3. The key coded lock according to claim 2, wherein the number of the driving blocks and the number of the connecting holes are both two; and the two driving blocks are symmetrically arranged relative to the axial line of the lock core.

4. The key coded lock according to any one of claims 1 to 3, wherein a spring plate is also arranged on the bottom shell and has a stator and elastic plates; one ends of the elastic plates are connected with the stator and the other ends of the elastic plates are positioned between the password wheels and the bottom shell; a pressure plate is arranged under the stator; both the stator and the pressure plate are provided with a plurality of circular holes engaged with each other; and a plurality of fixing columns engaged with the circular holes are formed in the middle of the surface shell and inserted into the circular holes.

5. The key coded lock according to claim 4, wherein through holes used for the rotation of the password wheels are formed on the left central section of the surface shell; an upper plughole is formed on the top left of the surface shell; the upper plughole and the lower plughole are engaged with each other to form a plughole for the first straightline section to be inserted; an upper lockhole is formed on the right bottom of the surface shell; the upper lockhole and the lower lockhole are engaged with each other to form a lockhole for mounting the lock core; an upper latch hook sleeve hole is formed on the top right of the surface shell; and the upper latch hook sleeve hole and the lower latch hook sleeve hole are engaged with each other to form a latch hook sleeve hole for mounting the latch hook sleeve.

6. The key coded lock according to claim 1, wherein a convex clamping block is formed on the side face of the first straightline section and positioned on the projections; the bottom shell is provided with a spacing hole; a stop block is formed inside the spacing hole; when the lower end face of the clamping block makes contact with the stop block, the lower end face of the second straightline section is positioned on the casing; a spacing groove along which the clamping block moves is formed aside the lower plughole of the bottom shell; and when the clamping block moves to the upper bottom of the spacing groove, the projections on the side face of the first straightline section are all positioned inside the annular columns of the password adjustment wheels corresponding to the projections and the lower end of the second straightline section is disengaged from the latch hook sleeve.

7. The key coded lock according to claim 1, wherein a lower password adjustment hole is formed on the left bottom of the bottom shell; a password adjustment spring is arranged inside the lower password adjustment hole; one end of the password adjustment spring is butted with a password adjustment wheel at the bottom and the other end of the password adjustment spring is butted with the lower end face of the lower password adjustment hole; and a spacer is arranged between the password adjustment spring and the password adjustment wheel.

8. The key coded lock according to claim 1, 2, 3, 6 or 7, wherein a password search device is arranged in the middle of the bottom shell and has a movable block and a plurality of password search rods; password search holes are formed on upper end portions of side faces of the password adjustment wheels; when the projections on the side face of the latch hook are engaged with the openings of the circular rings on the inner side faces of the password adjustment wheels, the password search holes turn towards the right; a plurality of mounting holes are formed on the front end portion of the left of the movable block; password search springs are arranged inside the mounting holes; one ends of the password search rods are extended into the mounting holes and butted with the password search springs and the other ends of the password search rods correspond to the password search holes; a password search device hole engaged with the password search device is formed in the middle of the bottom shell; offsetting springs are arranged on the left of the password search device hole; one ends of the offsetting springs are butted with the left end face of the password search device hole and the other ends of the offsetting springs are butted with the rear end portion of the left of the movable block; a push rod is formed on the side face of the sleeve; and when the sleeve is driven to rotate until the latch hook sleeve is extended into the casing, the push rod is positioned on the left of the sleeve.

9. The key coded lock according to claim 8, wherein a plurality of password search blocks protruded to the left are formed on the front end portion of the left of the movable block; the mounting holes of the movable block are formed on left end faces of the password search blocks and are conical through holes; and the password search rods are conical rods.

10. The key coded lock according to claim 1, wherein the sleeve consists of a spiral upper cover and a spiral lower cover; a clamping column is formed on the lower end face of the spiral upper cover; a clamping hole is formed on the upper end face of the spiral lower cover; and the clamping column is extended into the clamping hole.
